(19) United States
(12) Patent Application Publication
(10) Pub. No.: US 2016/0173787 A1
(43) Pub. Date: Jun. 16, 2016

(54) SURVEILLANCE CAMERA WITH HEAT MAP FUNCTION

(71) Applicant: IDIS CO., LTD., Daejeon-si (KR)

(72) Inventor: Seong Jin YUN, Seongnam-si (KR)

(73) Assignee: IDIS CO., LTD., Daejeon-si (KR)

(21) Appl. No.: 14/610,234

(22) Filed: Jan. 30, 2015

(30) Foreign Application Priority Data
Dec. 10, 2014 (KR) 10-2014-0177275

(51) Int. Cl. H04N 5/265; H04N 5/232

(52) U.S. Cl. CPC H04N 5/265; H04N 5/23229; H04N 5/23203

(57) ABSTRACT

A surveillance camera with a heat map function. The surveillance camera may include a heat map generator to generate a heat map image made of graphics that show a heat distribution by accumulating traces of a moving object within the original captured image; and a heat map combiner to combine the heat map image with the original image.

### CROSS-REFERENCE TO RELATED APPLICATION(S)

This application claims the benefit under 35 U.S.C. §119(a) of Korean Patent Application No. 10-2014-0177275, filed on Dec. 10, 2014, in the Korean Intellectual Property Office, the entire disclosure of which is incorporated herein by reference for all purposes.

### BACKGROUND

1. Field

The following description relates to a surveillance camera that remotely monitors surveillance areas, and particularly to a surveillance camera that captures the surveillance areas.

2. Description of the Related Art

Korean Patent No. 10-1054896 discloses a well-known technology of detecting movements with a camera. Furthermore, the Korean Patent No. 10-1054896 discloses a technology that identifies a moving object by using pixel differences between an image captured at a previous point in time and an image captured at the current point in time, detects the locations of the moving object, and controls the brightness according to the locations.

A security surveillance system consists of a surveillance camera and a receiving device that receives images from the surveillance camera. The receiving device analyzes the received images, identifies the moving objects, and tracks and displays the movement path on the monitor.

### SUMMARY

The following description relates to a technology for easily monitoring traces of movements and the frequency of their appearances in surveillance areas.

In one general aspect, a surveillance camera with a heat map function includes a heat map generator to generate a heat map image made of graphics that show a heat distribution by accumulating traces of a moving object within an original image that is captured; and a heat map combiner to combine the heat map image with the original image.

The heat map generator may include a foreground image extractor to extract, from the original image, a foreground image showing a moving object; a heat map data generator to generate heat map data by using the foreground image; and a heat map image generator to generate the heat map image by using the heat map data.

The surveillance camera may further include an image extractor to reduce a size of the original image and output the reduced original image to the foreground image extractor; and an image enlarger to enlarge the generated heat map image.

The surveillance camera may further include a transmitter to transmit an image into which the original image and the heat map image are combined.

The surveillance camera may further include a transmitter to transmit the heat map data.

In another general aspect, a method of generating a heat map image includes generating a heat map image made of graphics that show a heat distribution by accumulating traces of a moving object within an original image that is captured; and combining the heat map image with the original image.

The generating of the heat map image may include estimating a background image from the original image; extracting a foreground image acquired by excluding the estimated background image from the original image; generating heat map data by using the foreground image; and generating the heat map image by using the heat map data.

Other features and aspects may be apparent from the following detailed description, the drawings, and the claims.

### BRIEF DESCRIPTION OF THE DRAWINGS

FIG. 1 is a diagram illustrating an example of a surveillance camera with a heat map function.

FIG. 2 is a diagram illustrating an example of a heat map generator.

FIG. 3 is a diagram illustrating an example of an original image, a heat map image, and a combined image with the heat map image.

FIG. 4 is a flowchart illustrating an example of a method of generating a heat map image.

FIG. 5 is a flowchart illustrating an example of an operation 100 of generating a heat map image by accumulating traces of a moving object within an original image.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

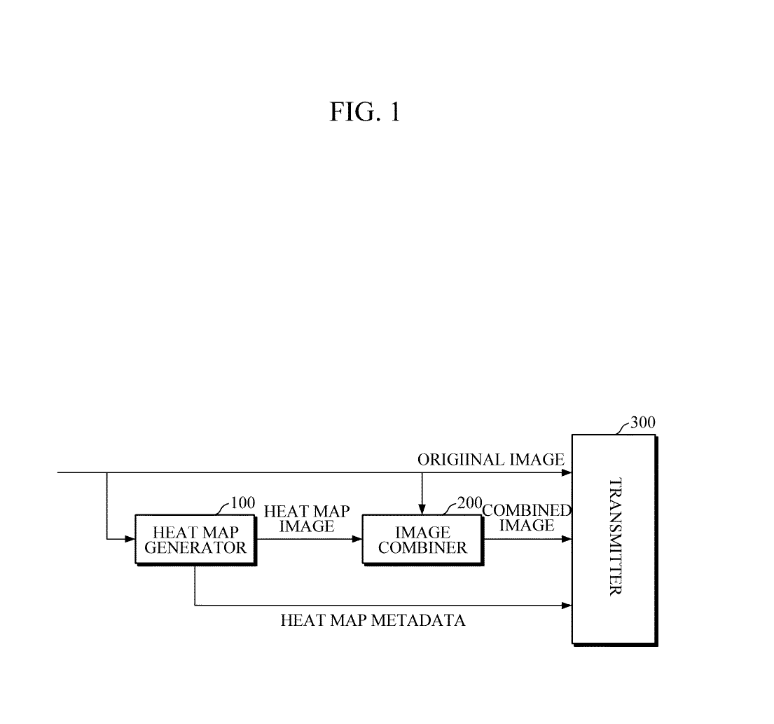

FIG. 1 is a diagram illustrating an example of a surveillance camera with a heat map function. A heat map generator 100 generates a heat map image by accumulating traces of a moving object within the original captured image. In other words, when any movements occur within the surveillance areas, the heat map generator 100 accumulates the traces of the movements and generates the heat map image based on the traces. Here, the heat map indicates graphics that show the heat distribution and visually represents each value of specific data as a color. A heat map combiner 200 combines the original image and a heat map image generated by the heat map generator 100. A transmitter 300 may transmit an image that is combined by a heat map combiner 200 to an external receiving device. The transmitter 300 may transmit the original image as well as the combined image, and also transmit heat map metadata that is used in generating the heat map image to the receiving device. For example, the receiving device may be a digital video recorder (DVR), a network video recorder (NVR), or the like.

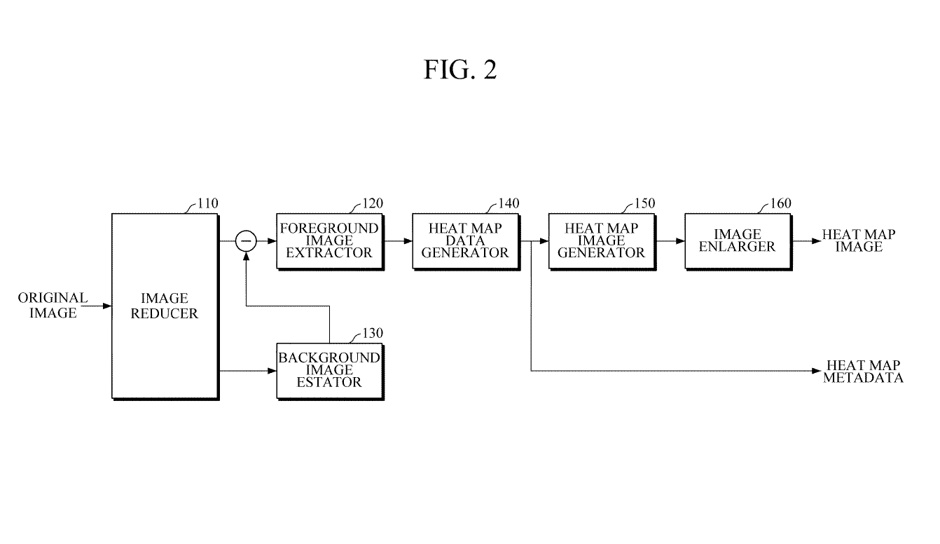

FIG. 2 is a diagram illustrating an example of a heat map generator. An image reducer 110 proportionally reduces the size of the original image. A foreground image extractor 120 extracts the foreground image from the reduced original image. Here, the foreground image indicates an image showing a moving object. In the exemplary embodiment, the foreground image extractor 120 may extract the foreground image by excluding a static background image from the original image. To this end, the heat map generator 100 may further include a background image estimator 130. The background image estimator 130 estimates the background image from the original image. In the exemplary embodiment, the background image estimator 130 estimates images of areas absent of continuous movements for a predetermined period of time to be the background image.

A heat map data generator 140 generates heat map data by using the foreground image that has been extracted from the original image by the foreground image extractor 120. The heat map data generator 140 accumulates the movement traces of the moving objects from the continuously input foreground image frames, and generates the movement traces into the heat map data. Here, the heat map data indicates metadata used for generating heat map images. In an exemplary embodiment, the heat map data may include information, which is required for generating the heat map images, such as pixel coordinates values, the occurrence time, or an elapsed time of the trace areas which the moving objects make. The heat map data may include color values for each pixel. The initial color value may be any color between red and blue and be updated as time elapsed.

A heat map image generator 150 generates the heat map image by using the heat map data. In an exemplary embodiment, the heat map image generator 150 may generate the heat map image by applying the predetermined colors to pixels corresponding to the pixel coordinates values included in the heat map data. The initial color value for each pixel may be any color between red and blue. The red indicates a high temperature, and the blue indicates a low temperature. The first appearance color of the object may be any color between red and blue. Alternatively, the initial color value may be blue. The heat map image generator 150 may generate the heat map image by applying the initial color value to the pixels. In an exemplary embodiment, the heat map image generator 150 may update the heat map image by changing gradually (by a predetermined unit), to blue, the pixels in the area where the moving object passes by and changing gradually, to red, the pixels in the area where the moving object stays, as time elapsed.

In another exemplary embodiment, the heat map image generator 150 may maintain the initial color value with respect to the pixels in the area where the moving object has passed by, and gradually change only the colors of the pixels in the area where the moving object stays. For example, the heat map image generator 150 may gradually change, to red, the colors of the pixels corresponding to the moving object until the moving object stops for a long period of time and is recognized as the background.

In an exemplary embodiment, the initial color value may be more than two. For example, the central area and the surrounding area of the movement traces of the object may be represented as different colors. Thus, it is represented that the temperature in the central area is higher than the one of the surrounding area.

An image enlarger 160 proportionally enlarges the heat map image to be scaled to the original image. The reason why the size of the original image is reduced, and the heat map image is generated using the reduced original image and is enlarged to the original image, is to reduce the computation amount. Thus, the reduction of the computation amount enables quick image processing. In an exemplary embodiment, the image reducer 110 and the image enlarger 160 may be omitted.

A transmitter 300 may transmit the combined image, into which the heat map image and the original image are combined, to a receiving device as well as the original image. The transmitter 300 may also transmit heat map metadata to the receiving device so as to additionally use the heat map metadata in the receiving device.

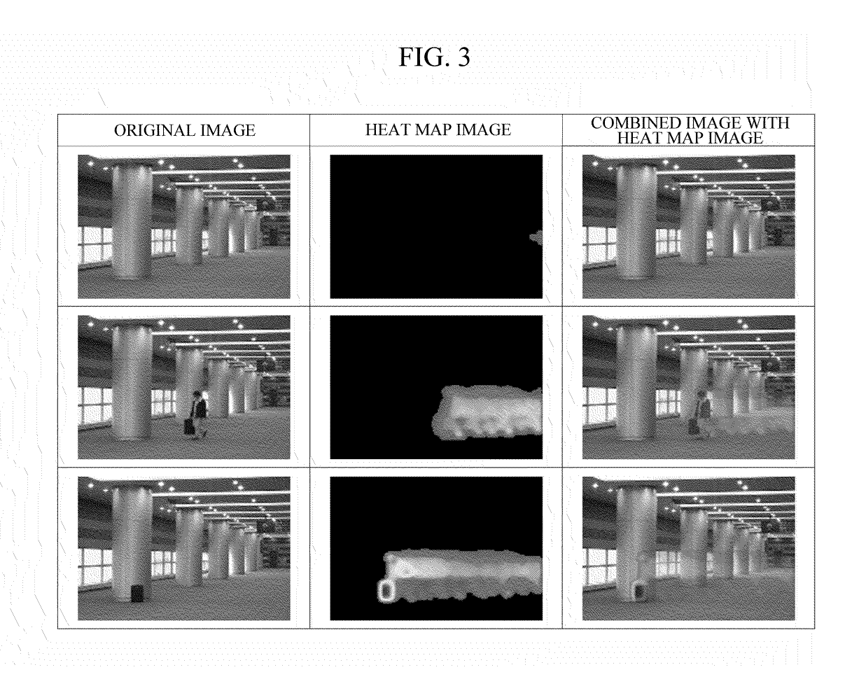

FIG. 3 is a diagram illustrating an example of an original image, a heat map image, and a combined image with the heat map image. When a moving object is detected from the original image, a heat map image is generated as illustrated in FIG. 3. It is shown that the colors shown in the heat map image are gradually changing as time elapsed. It is shown that the area where the moving object has passed by is turning blue, and the area identified as the background is turning red.

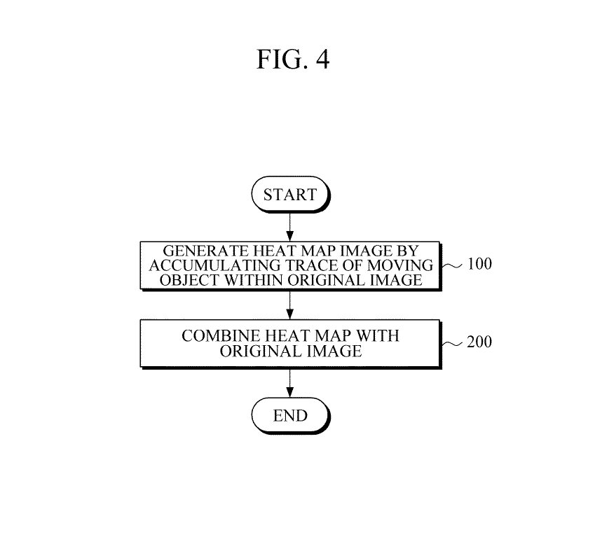

FIG. 4 is a flowchart illustrating an example of a method of generating a heat map image. The method of generating a heat map image as illustrated in FIG. 4 may be performed by a surveillance camera. However, the method is not limited thereto, and may be performed by an additional computing device. Hereinafter, the method is described considering the surveillance camera as a subject of the operations mentioned below for convenience of description. The surveillance camera generates a heat map image in 100, which indicates graphics that show a heat distribution by accumulating the movement traces when the moving object is detected within the original captured image. The heat map image is combined with the original image in 200. The surveillance camera may transmit the combined image to a receiving device as well as the original image.

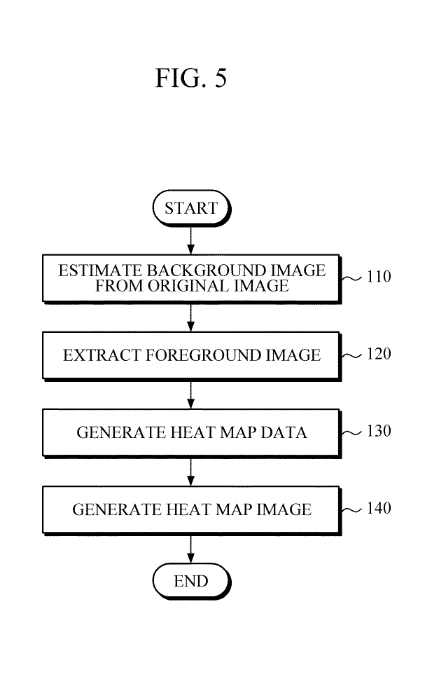

FIG. 5 is a flowchart illustrating an example of an operation 100 of generating a heat map image by accumulating traces of a moving object within an original image. A surveillance camera estimates a background image in 110. In an exemplary embodiment, the surveillance camera estimates images of areas absent of movements for a predetermined period of time to be the background image. When the background image is estimated, the surveillance camera extracts a foreground image in 120 by excluding the background image from the foreground image. The surveillance camera generates heat map data through the accumulation of the extracted foreground image frames in 130. The surveillance camera generates the heat map image by using the generated heat map data in 140.

In the existing technology, a process of, by a receiving device, extracting a moving object from a received image, identifying the object, and tracking its movement is required. Thus, not a general receiving device but a special device is required so as to perform complicated processes

However, the present disclosure may provide a monitoring function properly while reducing the computation amount through a manner of extracting a foreground image and directly using it in heat map accumulation. Also, the present disclosure may provide a function of certainly monitoring movement traces of an object and appearance frequencies through the heat map image. Since the surveillance camera performs operations mentioned above, a general receiving device is available

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A surveillance camera capturing a surveillance area transmitting the captured image, comprising:
a heat map generator configured to generate a heat map image made of graphics that show a heat distribution by accumulating traces of a moving object within an original image that is captured; and
a heat map combiner configured to combine the heat map image with the original image.

2. The surveillance camera of claim 1, wherein the heat map generator comprises:
a foreground image extractor configured to extract, from the original image, a foreground image showing a moving object;
a heat map data generator configured to generate heat map data by using the foreground image; and
a heat map image generator configured to generate the heat map image by using the heat map data.

3. The surveillance camera of claim 2, further comprising:
an image extractor configured to reduce a size of the original image and output the reduced original image to the foreground image extractor; and
an image enlarger configured to enlarge the generated heat map image.

4. The surveillance camera of claim 2, further comprising:
a transmitter configured to transmit an image into which the original image and the heat map image are combined.

5. The surveillance camera of claim 2, further comprising:
a transmitter configured to transmit the heat map data.

6. A method of generating a heat map image, comprising:
generating a heat map image made of graphics that show a heat distribution by accumulating traces of a moving object within an original image that is captured; and
combining the heat map image with the original image.

7. The method of claim 6, wherein the generating of the heat map image comprises:
estimating a background image from the original image;
extracting a foreground image acquired by excluding the estimated background image from the original image;
generating heat map data by using the foreground image; and
generating the heat map image by using the heat map data.
